(19) United States
(12) Patent Application Publication
(10) Pub. No.: US 2009/0172547 A1
(43) Pub. Date: Jul. 2, 2009

(54) SYSTEM AND METHOD FOR DYNAMICALLY PUBLISHING MULTIPLE PHOTOS IN SLIDESHOW FORMAT ON A MOBILE DEVICE

(76) Inventor: Michael J. Sparr, Missoula, MT (US)

Correspondence Address: ANTOINETTE M. TEASE, P. O. BOX 51016, BILLINGS, MT, 59105, US

(21) Appl. No.: 12/135,115

(22) Filed: Jun. 6, 2008

Related U.S. Application Data
(62) Division of application No. 61/009,552, filed on Dec. 31, 2007.

(51) Int. Cl. G06F 3/00

(52) U.S. Cl. 715/730

(57) ABSTRACT

A system for publishing multiple photos in slideshow format on a mobile device comprising: means for inputting multiple photo file references to a slideshow generator; a slideshow generator that parses the inputted photo file references, retrieves photo files based on the parsed photo file references, assembles the retrieved photo files into frames, and aggregates the frames into a single, animated slideshow file that rotates through all of the photos based on a specified time delay; a database that stores photo file reference information; a file storage system that stores the aggregated slideshow file generated by the slideshow generator; means for delivering the aggregated slideshow file to a mobile device; and means for rendering the slideshow file as a slideshow on a mobile device. A method for publishing multiple photos in slideshow format on a mobile device using the above-described system.

### CROSS-REFERENCE TO RELATED APPLICATION

This application claims priority back to U.S. Patent Application No. 61/009,552 filed on 31 Dec. 2007. The contents of that application are hereby incorporated by reference into the present disclosure.

### BACKGROUND OF THE INVENTION

1. Field of the Invention

The present invention relates generally to the field of computer-implemented inventions, and more specifically, to a system and method for dynamically publishing multiple photos in slideshow format on a mobile device using a web-based application.

2. Description of the Related Art

As used herein, the term “mobile marketing” refers to marketing products and/or services over mobile devices, such as personal digital assistants (PDAs) or cell phones. In connection with this type of marketing, it is desirable to have the capability of offering potential consumers a visual depiction of the product or service, such as a photograph or video. Current technologies, however, fall short of providing the user with a meaningful and cost-effective marketing experience.

Existing solutions for mobile marketing allow publishers to upload individual photos, but they can only deliver a single photo per message or link to photos on a mobile web page. This results in increased messaging, airtime and other charges and a poor user experience for potential buyers. With prior art technology, if a mobile device is used to view multiple photos, either the device is unusable while it downloads multiple photos, or else the user has to go to a mobile web page, click on multiple links and/or scroll the page to view the photos. Both of these methods are inconvenient and result in increased costs, both in terms of the user's time and messaging/airtime fees.

One market where the ability to present the potential consumer with a visual depiction of the product over a mobile device is particularly valuable is the real estate industry because prospective buyers can pull up visual images of a property as they drive by it. These services typically work by requiring the buyer to send a text message to the service, which then sends the photos to the buyer's cell phone. In today's real estate market, buyers prefer to have instant access to information about properties, and the best way to provide that information is via a mobile device.

Existing methods of delivering photos to consumers are tedious and costly, for the reasons described above. For example, one real estate sales website (www.House4Cell.com) sends up to three photos—one after another—to a cell phone. Another real estate sales website (www.CellAHouse.com) directs the user to a mobile web page, where the user can click between different photos. Neither of these methods, however, provides the user with a quick and satisfactory way to view multiple photos at once.

A number of published patent applications describe various technologies for generating, delivering and/or presenting media on wireless devices, but none of these references involves generating a single Graphics Interchange Format (GIF) file from multiple photos and enabling those photos to be played on a mobile device as a slideshow generated by a web application.

For example, U.S. Patent Application Pub. No. 20060256130 (Gonzalez) provides a system for delivery and presentation of multimedia on a wireless device, but this system delivers a separate player application to the user's cell phone. This player application reads the XML file generated by the invention and aggregates the media for presentation to the user on the cell phone. The present invention does not require a separate player application.

U.S. Patent Application Pub. No. 20060230073 (Gopalakrishnan) discloses an augmented reality system in which computer-generated information is used to “enhance” the real-world environment. For example, the invention purports to cover the process of a user capturing visual information, the system generating contexts from inputs presented to the user (or the user defining a context manually), and the user inputting content (such as video) to be associated with the selected contexts. This “newly authored content” is then added to the system's knowledge base and can be accessed by users of the system to obtain information relevant to contexts similar to the context with which the newly authored content is associated. The software is accessed via a “client device,” which can be a PDA or cell phone. This invention does not involve the aggregation of multiple photos into a single GIF file for presentation to a user as a video on a mobile device.

U.S. Patent Application Pub. No. 20030191816 (Landress et al.) describes various methods for digitally transforming images, including melding, bluescreening and morphing. The application is entitled “System and method for creating and delivering customized multimedia communications,” and it generally covers a system and method for providing interactive and customizable digital full-motion, animated and static multimedia content to be used for communicating unique personalized entertainment, information, messages and advertising. This information is delivered via the Internet, electronic mail, or any other method of delivering interpersonal communications and messages (which, presumably, would include text messaging). This application does not discuss the generation of a single GIF image from multiple photos and the delivery of that file to a mobile device in the form of a slideshow that can be viewed by the user without the need for a separate player application.

U.S. Patent Application Pub. No. 20070239788 (Cunningham et al.) provides an apparatus for generating and editing media assets based on context. The term “context” includes user objectives, such as generating a real estate video. In one embodiment (a method for generating a media asset), the invention generates a “video asset” based on an optimized master asset and identification of starting and ending frames in the optimized master asset. In an alternate embodiment (a method for rendering a media asset), the invention renders an “aggregate media asset” that is defined by an edit specification. In yet another embodiment (a method for storing an aggregate media asset), a stream corresponding to the aggregate media asset is received in a playback session from a remote computing device. Mobile phones are mentioned as one type of computing system that may be used to implement processing functionality. Nowhere in this patent application does it mention or discuss the aggregation of photos into a single GIF file for purposes of displaying a slideshow to a consumer on a mobile device.

The present invention solves the problems inherent in the prior art methods of delivering multiple photos to consumers via text messaging, and it addresses a problem that does not appear to have been addressed in any of the patent literature to date. The present invention also provides added features such as photo captions, delay between slides, and photos size, all of which are described more fully below.

### BRIEF SUMMARY OF THE INVENTION

The present invention is a system for publishing multiple photos in slideshow format on a mobile device comprising: means for inputting multiple photo file references to a slideshow generator; a slideshow generator that parses the inputted photo file references, retrieves photo files based on the parsed photo file references, assembles the retrieved photo files into frames, and aggregates the frames into a single, animated slideshow file that rotates through all of the photos based on a specified time delay; a database that stores photo file reference information; a file storage system that stores the aggregated slideshow file generated by the slideshow generator; means for delivering the aggregated slideshow file to a mobile device; and means for rendering the slideshow file as a slideshow on a mobile device.

In a preferred embodiment, the each frame comprises a background, a header, and a photo file. Preferably, each frame further comprises a textual caption.

In a preferred embodiment, the slideshow generator resizes each retrieved photo file to specified width and height constraints, converts a textual caption into an image file, layers the resized photo and the caption image file on top of a background to create a frame, and appends the frame to a slideshow frameset with frame control data. Preferably, the slideshow generator uses Sun Java AWT library functions to resize the retrieved photo file to specified width and height constraints. Preferably, the slideshow generator uses Sun Java 2D library functions to convert the textual caption to an image file, layer the resized photo and caption image file on top of a background to create a frame, and append the frame to a slideshow frameset with frame control data. In a preferred embodiment, the frame control data comprises a time delay period for each photo.

In a preferred embodiment, the means for inputting the photo file references to the slideshow generator is a web-based submission form. Preferably, the web-based submission form comprises one or more fields for entering photo file references, one or more fields for entering photo captions, one or more fields for entering a delay period between photos in the slideshow, one or more fields for entering photo size, and a window in which the slideshow can be viewed prior to publication. Preferably, the web-based submission form further comprises a field for entering the name of the slideshow, a field for entering a reference to a file that will form a background for the photos in the slideshow, a field for entering the font for the slideshow name and the photo captions, and a field for specifying slideshow size. In a preferred embodiment, the web-based submission form displays a preview of the slideshow after the slideshow file is generated.

In a preferred embodiment, the means for inputting the photo file references to the slideshow generator is an Application Programming Interface call. Preferably, the Application Programming Interface call submits to the slideshow generator metadata regarding slideshow name, slideshow size, photo size, font family and size, and time delay period between photos. Preferably, the metadata submitted by the Application Programming Interface call to the slideshow generator includes file reference information for the photos, textual captions, and size and delay override values.

In a preferred embodiment, the slideshow file is a Graphics Interchange Format file. Preferably, the slideshow file is in GIF89a file format.

In a preferred embodiment, the system allows a publisher to specify a time delay period for each photo or to utilize a default time delay period for all photos. Preferably, the slideshow generator uses Sun Java Simple API for XML to parse the inputted photo file references. In one embodiment, the slideshow generator uses Sun Java NET library to retrieve photo files based on the parsed photo file references. In an alternate embodiment, the slideshow generator uses Apache Software Foundation Commons HTTP Client libraries to retrieve photo files based on the parsed photo file references.

In a preferred embodiment, the database is a MySQL relational database. Preferably, the file storage system is a local disk or a remote file storage device.

The present invention is also a method for publishing multiple photos in slideshow format on a mobile device comprising: inputting multiple photo file references to a slideshow generator; parsing the inputted photo file references, retrieving photos based on the parsed photo file references, assembling the retrieved photo files into frames, and aggregating the frames into a single, animated slideshow file that rotates through all of the photos based on a specified time delay; storing the photo file reference information in a database; storing the aggregated slideshow file in a file storage system; delivering the aggregated slideshow file to a mobile device; and rendering the slideshow file as a slideshow on a mobile device.

In a preferred embodiment, each frame comprises a background, a header, and a photo file. Preferably, each frame further comprises a textual caption.

In a preferred embodiment, the method further comprises resizing each retrieved photo file to specified width and height constraints, converting a textual caption into an image file, layering the resized photo and the caption image file on top of a background to create a frame, and appending the frame to a slideshow frameset with frame control data. Preferably, the step of resizing each retrieved photo file to specified width and height constraints is accomplished using Sun Java AWT library functions. Preferably, the steps of converting the textual caption to an image file, layering the resized photo and caption image file on top of a background to create a frame, and appending the frame to a slideshow frameset with frame control data are accomplished using Sun Java 2D library functions. In a preferred embodiment, the frame control data comprises a time delay period for each photo.

In a preferred embodiment, the photo file references are inputted using a web-based submission form. Preferably, the web-based submission form comprises one or more fields for entering photo file references, one or more fields for entering photo captions, one or more fields for entering a delay period between photos in the slideshow, one or more fields for entering photo size, and a window in which the slideshow can be viewed prior to publication. Preferably, the web-based submission form further comprises a field for entering the name of the slideshow, a field for entering a reference to a file that will form a background for the photos in the slideshow, a field for entering the font for the slideshow name and the photo captions, and a field for specifying slideshow size. In a preferred embodiment, the web-based submission form displays a preview of the slideshow after the slideshow is generated.

In a preferred embodiment, the photo file references are inputted using an Application Programming Interface call. Preferably, the Application Programming Interface call submits metadata regarding slideshow name, slideshow size, photo size, font family and size, and time delay period between photos. Preferably, the metadata submitted by the Application Programming Interface call includes file reference information for the photos, textual captions, and size and delay override values.

In a preferred embodiment, the slideshow file is a Graphics Interchange Format file. Preferably, the slideshow file is in GIF89a file format.

In a preferred embodiment, the method allows a publisher to specify a time delay period for each photo or to utilize a default time delay period for all photos. Preferably, the inputted photo file references are parsed using Sun Java Simple API for XML. In one embodiment, the photo files are retrieved using Sun Java NET library. In an alternate embodiment, the photo files are retrieved using Apache Software Foundation Commons HTTP Client libraries.

In a preferred embodiment, the database is a MySQL relational database. Preferably, the file storage system is a local disk or a remote file storage device.

### BRIEF DESCRIPTION OF THE DRAWINGS

FIG. 1 is a schematic diagram of the primary components of the present invention.

FIG. 2 is a flow diagram of the content creation aspect of the present invention.

FIG. 3 is an illustration of the steps involved in creating content according to the present invention.

FIG. 4 is a first screen shot of the user input form of the present invention.

FIG. 5 is a second screen shot of the user input form of the present invention.

FIG. 6 is a flow diagram of the content delivery aspect of the present invention.

FIG. 7 is an illustration of the steps involved in delivering content according to the present invention.

FIG. 8 is a flow diagram of the content usage aspect of the present invention.

FIG. 9 is an illustration of the steps involved in using content according to the present invention.

### DETAILED DESCRIPTION OF INVENTION

The present invention is a web-based software application that accepts multiple photo files (either by Uniform Resource Locator (URL) reference or by uploading them to a server) and dynamically aggregates those files into a single, animated slideshow that rotates through all of the photos based on a specified time delay. The present invention accepts the multiple photo files either via web form submission or an Application Programming Interface (API) call. The present invention utilizes GIF file format, which mobile devices are capable of rendering, and provides publishers a mechanism for delivering photos to consumers in a single file that is sent to a mobile device.

The present invention allows users to (i) resize the images that are displayed on the mobile device during file generation by accepting input parameters and using image resizing features of the programming language toolset, (ii) specify a period of delay between the presentation of each photo image in the generated slideshow file (either via user input on a per-image basis or based on pre-configured default values stored in a text or XML property file), and (iii) add captions to the photos. As explained more fully below, the present invention dynamically generates image files of the textual captions, resizes the photo files, and aggregates them into frames. These frames are then aggregated into a single, photo slideshow file stored on a web server that can be delivered to a mobile device. The file can be retrieved either by addressing its location directly in a browser or by “pushing” it to the mobile device using WAP Push, Multimedia Messaging Service (MMS), or any other binary content delivery specifications for Short Message Service (SMS) messages.

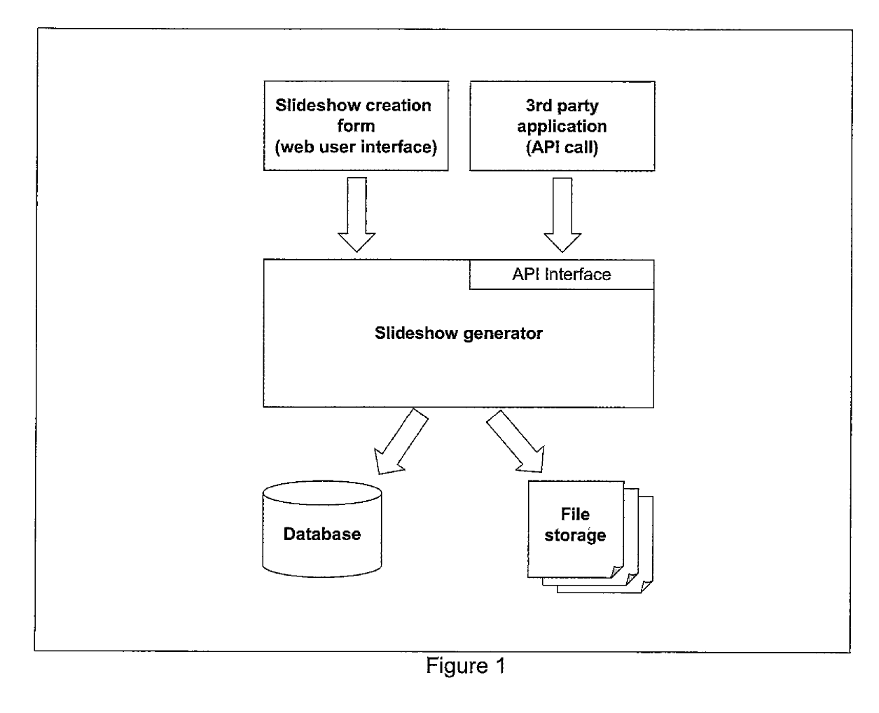

FIG. 1 is a schematic diagram of the primary components of the present invention. This diagram shows the slideshow generation form, slideshow generator with API interface, file system for storing photo slideshows, and database for persisting file reference data. The slideshow generation form of the present invention is a web-based form that allows the publisher to select photos, enter textual captions and invoke the slideshow generation process (content creation). The API interface of the present invention accepts data in XML format from a third-party system, allowing that system to invoke the slideshow generation process. The slideshow generator of the present invention accepts either form or API input and parses the input for processing. In a preferred embodiment, the system of the present invention uses Sun Java SAX (Simple API for XML) parser. The slideshow generator retrieves referenced photo files, generates a photo slideshow, stores the generated file to a file system, and persists file reference information to a database. The file system can be a local disk or a remote file storage device. In a preferred embodiment, the system of the present invention uses functions of Sun Java NET library for file retrieval. In a preferred embodiment, the database is a MySQL relational database. These components are explained more fully below, as part of the content creation aspect of the present invention.

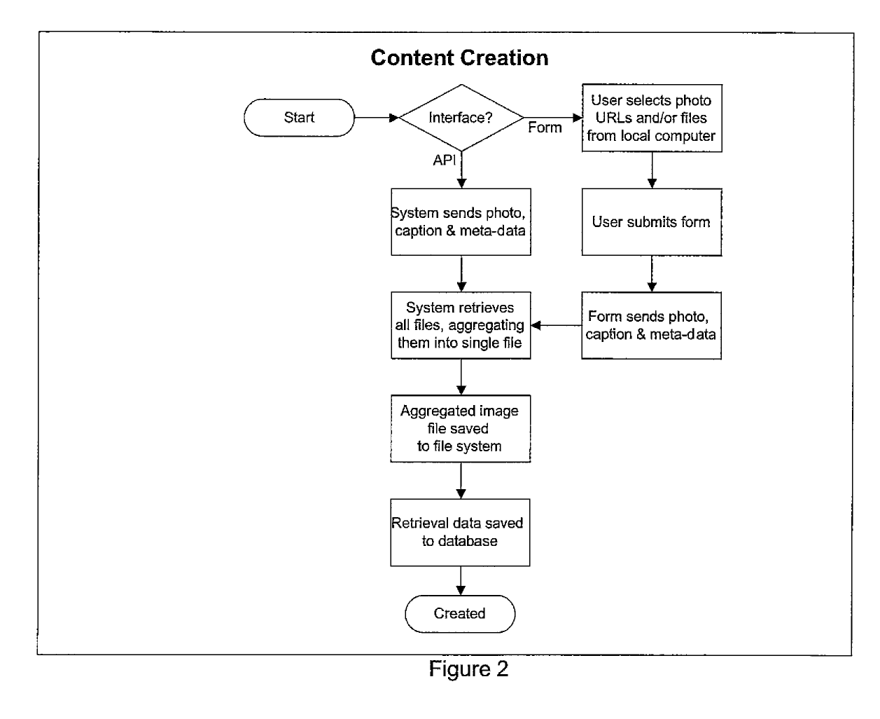

The present invention encompasses content creation, content delivery and content usage. These aspects of the invention are depicted in FIGS. 2-9 and discussed below.

A. Content Creation

FIG. 2 is a flow diagram of the content creation aspect of the present invention. The content creation occurs within the slideshow generator depicted in FIG. 1. There are two possible input methods to invoke content creation—form data submission and API call. Form data submission allows the publisher to manually select photos, enter textual captions for each photo, and edit optional control data. API calls submit the same information as form submission, structured in XML, whose elements include optional configuration parameters for slideshow name, slideshow size, photo size, font family and size, and default delay in seconds between frames. The API call information also includes a list of photo records with photo URL, associated textual caption, and optional size and delay override values. The slideshow generator parses the input, retrieves files, assembles individual photo frames for each list item, and aggregates each frame into the generated photo slideshow file. The present invention then saves the generated aggregate file to a file system and saves file retrieval information to a database. In a preferred embodiment, the present invention uses functions of the Sun Java AWT (Abstract Windowing Toolkit) library, Sun Java 2D library and the Sun Java 10 library for file manipulation, image resizing, frame assembly and writing control data for slideshow generation in GIF89a format. In a preferred embodiment, the present invention uses functions of the Sun Java 10 library for storing the generated file to the file system. In a preferred embodiment, the present invention uses functions of the JDBC (Java Database Connectivity) driver for MySQL database to persist file reference information to the database.

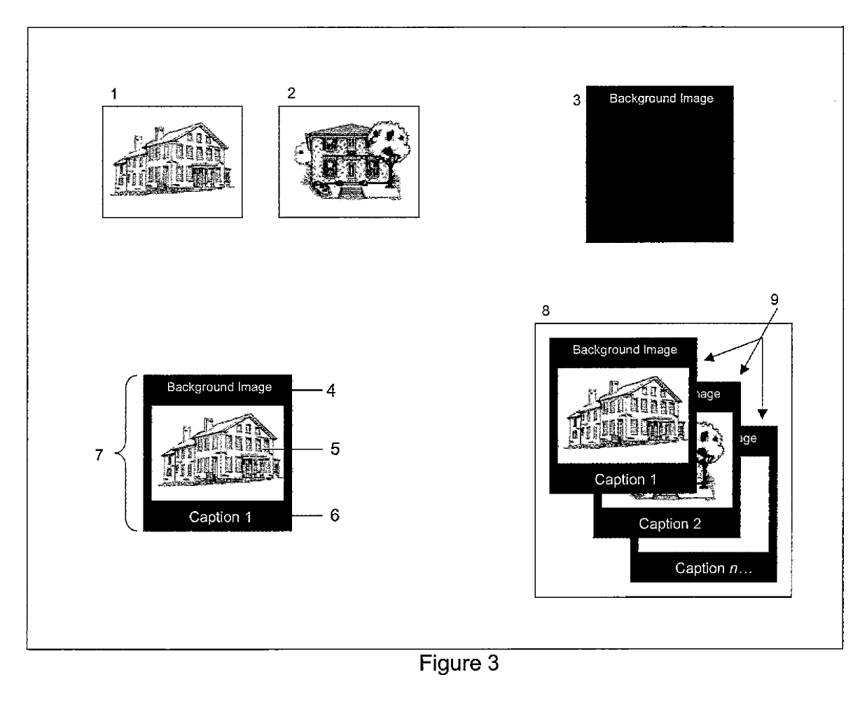

FIG. 3 is an illustration of the steps involved in creating content according to the present invention. Described in FIG. 2, the slideshow generator parses a list of photo and related metadata information, assembles frames, and appends the generated frame for each photo into an animated photo slideshow. The content assembly process involves one or more photos 1, 2, an optional background image 3, and optional textual captions. In a preferred embodiment, the system of the present invention uses XML configuration data defining application constraints for slideshow width and height, photo width and height, delay in seconds between frames, font family and size, and the URL for the background image during processing and content creation. In a preferred embodiment, each generated frame 7 consists of the background 4, preferably with text or logo header, a resized photo 5 and textual caption 6. The photo slideshow 8 is a single file consisting of multiple frames 9 with control data based on GIF89a specification for playback rendering instructions for delay in seconds between frames. In a preferred embodiment, the present invention uses the Sun Java NET library functions to retrieve the background image file.

As the present invention iteratively parses the form or API input, it retrieves each photo 1, 2, preferably using Sun Java NET or Apache Software Foundation Commons HTTP Client libraries. Although two photos are shown in FIG. 3, any number of photos could be used to generate the slideshow. Based on the XML configuration parameters, the present invention resizes the downloaded photo files to the specified width and height constraints, preferably using the Sun Java AWT library functions. In a preferred embodiment, the present invention uses the Sun Java 2D library to convert the textual caption into an image file, layer the resized photo and the generated caption image on top of the background to create a frame 7, and append the generated frame to the photo slideshow frameset with frame control data (delay in seconds). This process is repeated for each photo in the list until reaching the end, resulting in a single animated photo slideshow file 8 with multiple frames 9.

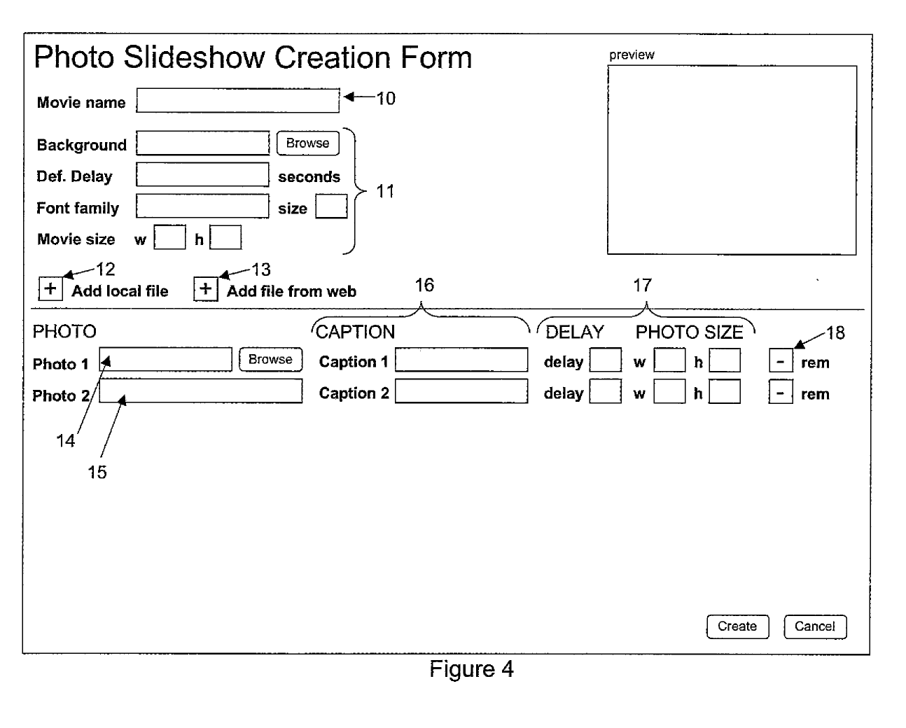

FIG. 4 is a first screen shot of the user input form of the present invention. The user enters a slideshow name 10, optional configuration parameters 11 and selects photos for inclusion in the photo slideshow. In a preferred embodiment, the user can dynamically create form fields depending on the source of each photo. The user selects a local file by clicking the local file button 12, dynamically generating a new form field row 14 that allows the user to click the “Browse” button and select a file from his PC. The user can select a remote file by clicking the web file button 13, dynamically generating a new form field row 15. The input field 15 allows the user to type in a URL to a photo file. For each photo, the user preferably enters a textual caption 16 to describe the photo and optionally enters in control data 17, such as delay in seconds and photo width and height. In a preferred embodiment, prior to submitting the user input form, the publisher can optionally delete any photo rows by clicking the delete button 18.

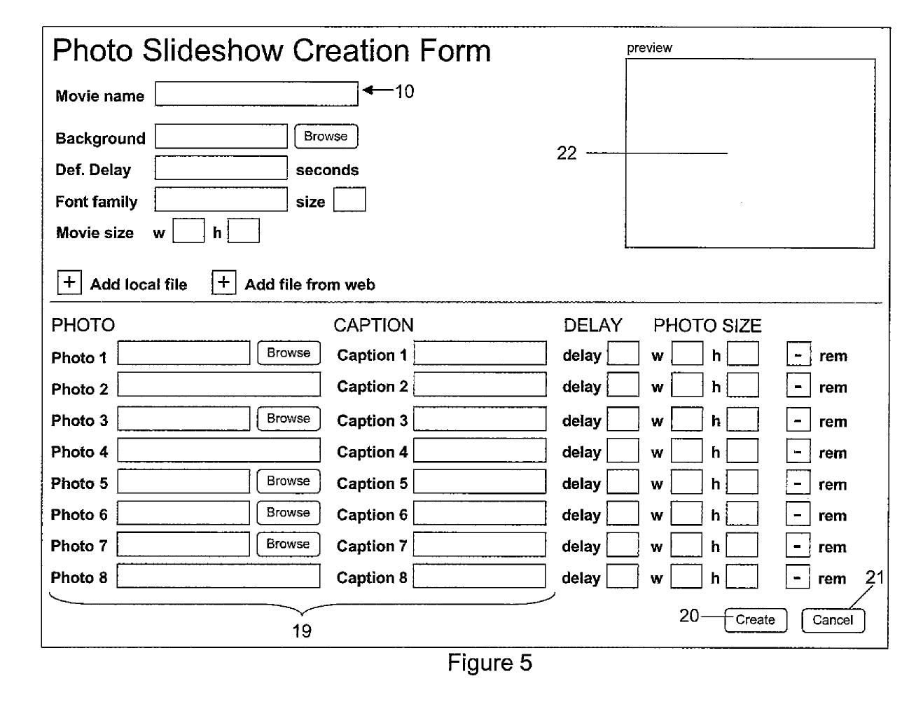

FIG. 5 is a second screen shot of the user input form of the present invention. As shown in FIG. 4, the user (or publisher) selects photos either from his local PC or by entering a photo URL. FIG. 5 shows a depiction of the user input form with multiple photo field rows 19 and illustrates how, in a preferred embodiment of the present invention, the user input form allows the publisher to select photos from either source. Upon selecting all desired photos 19, entering textual captions and optional control data, the user can either cancel by clicking the cancel button 21 or submit the form by clicking the create (or submit) button 20. The form data is submitted to the slideshow generator and invokes the content creation process as shown in FIG. 2. In a preferred embodiment of the present invention, after the photo slideshow is generated, the user input form will display a preview 22 of the generated content.

B. Content Delivery

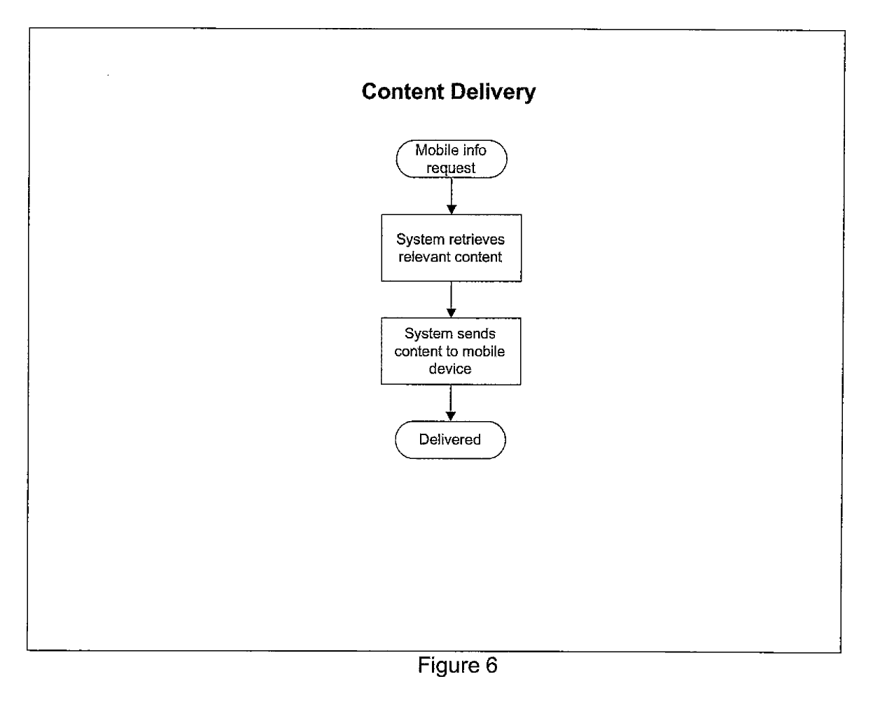

FIG. 6 is a flow diagram of the content delivery aspect of the present invention. A mobile device user sends a request via SMS to a designated number. The inbound request invokes an application to retrieve relevant content associated with the keyword sent in the body of the SMS message and sends a response message with instructions for the mobile device to retrieve the content. In a preferred embodiment, the response message is encoded as a WAP push message, and the mobile device is a cellular phone capable of decoding WAP push messages and downloading the referenced file. In an alternate embodiment, the reference to the content file can either be sent via MMS or referenced as a textual URL in the body of the response message. Given various protocols for delivering binary content over wireless networks, any means of delivering or referencing the content to enable user download and viewing would be sufficient.

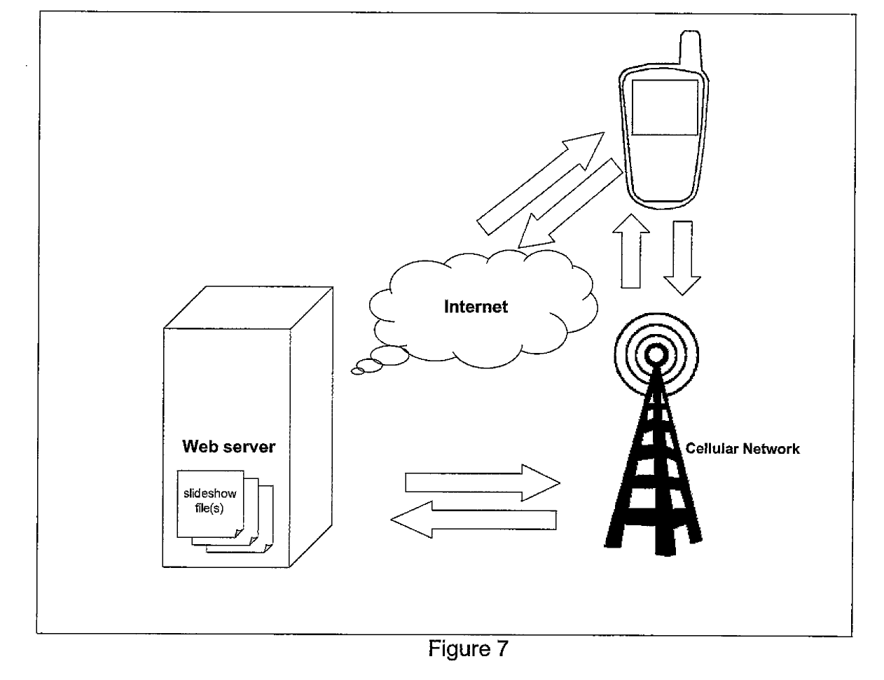

FIG. 7 is an illustration of the steps involved in delivering content according to the present invention. FIG. 7 shows the mobile device—preferably a cellular phone—sending a message via mobile network. The mobile network sends the message to an application designed to process these messages, the application identifies the associated content and sends a response message back to the wireless network, and the wireless network directs that message back to the mobile device. In a preferred embodiment, the mobile device then connects to the Internet over the data channel of the mobile network of which the mobile device is a member and downloads the content.

C. Content Usage

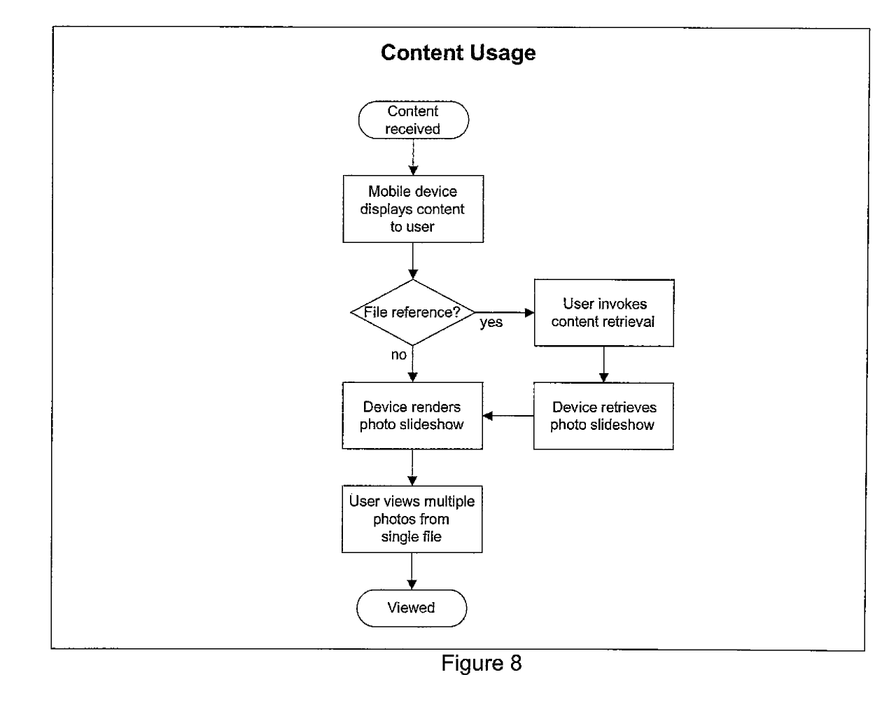

FIG. 8 is a flow diagram of the content usage aspect of the present invention. As previously described, the present invention allows users to view multiple photos, with optional captions, in a slideshow format over a mobile device. The mobile device is capable of rendering a single animated GIF file, stored in GIF89a format, and executes playback upon content rendering. The present invention allows mobile device users to receive multiple photos and information in a single transaction, as described above. As shown in FIG. 8, the mobile device either displays a reference (or URL) to the content file or automatically begins the download process using standard binary protocols such as WAP push or MMS, depending on wireless network. In a preferred embodiment, the content is automatically downloaded to the mobile device. In an alternate embodiment, the mobile device user is prompted with a URL, selects the link and invokes the mobile device browser to retrieve the referenced file. The mobile device then renders the file on its screen and proceeds to play through the slideshow, displaying multiple photos and optional captions to the mobile device user.

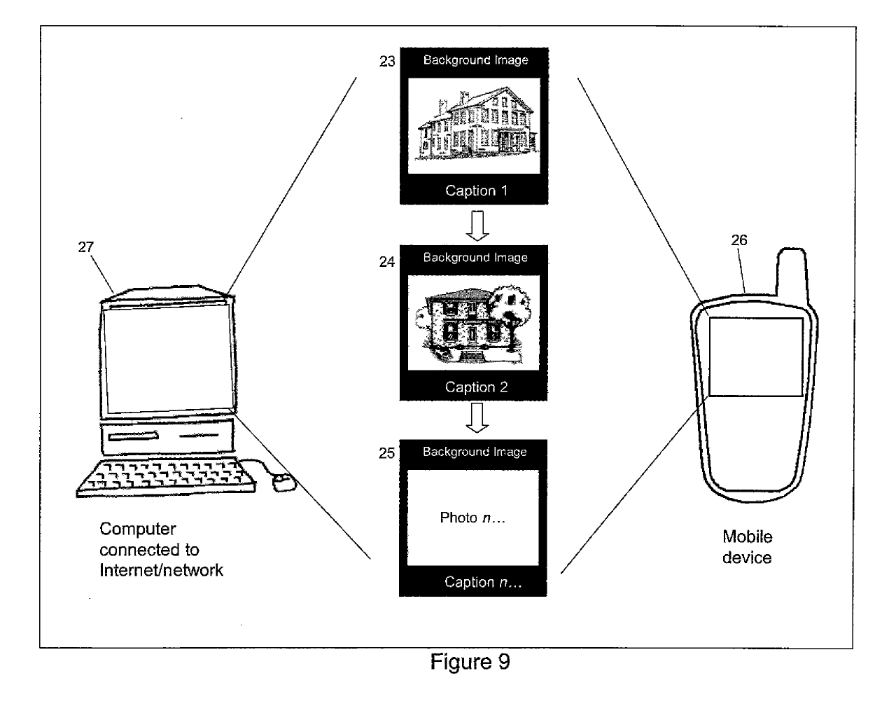

FIG. 9 is an illustration of the steps involved in using content according to the present invention. Because the generated photo slideshow file is stored on a server, preferably a web server connected to the Internet, the physical file can be referenced via URL and thus retrieved over any device browser capable of accessing the file and rendering the GIF file format. FIG. 9 illustrates that either a mobile device 26 or personal computer 27 could retrieve the content and render it for the user. As described above, and illustrated in FIG. 8, the photo slideshow is a single file that allows the user to view multiple photos in one download. FIG. 8 depicts the usage of this content by illustrating the display of a first photo 23, a second photo 24, and as many subsequent photo frames 25 as are stored in the animated photo slideshow file.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A system for publishing multiple photos in slideshow format on a mobile device comprising:
(a) means for inputting multiple photo file references to a slideshow generator;
(b) a slideshow generator that parses the inputted photo file references, retrieves photo files based on the parsed photo file references, assembles the retrieved photo files into frames, and aggregates the frames into a single, animated slideshow file that rotates through all of the photos based on a specified time delay;
(c) a database that stores photo file reference information;
(d) a file storage system that stores the aggregated slideshow file generated by the slideshow generator;
(e) means for delivering the aggregated slideshow file to a mobile device; and
(f) means for rendering the slideshow file as a slideshow on a mobile device.

2. The system of claim 1, wherein each frame comprises a background, a header, and a photo file.

3. The system of claim 2, wherein each frame further comprises a textual caption.

4. The system of claim 1, wherein the slideshow generator resizes each retrieved photo file to specified width and height constraints, converts a textual caption into an image file, layers the resized photo and the caption image file on top of a background to create a frame, and appends the frame to a slideshow frameset with frame control data.

5. The system of claim 4, wherein the slideshow generator uses Sun Java AWT library functions to resize the retrieved photo file to specified width and height constraints.

6. The system of claim 4, wherein the slideshow generator uses Sun Java 2D library functions to convert the textual caption to an image file, layer the resized photo and caption image file on top of a background to create a frame, and append the frame to a slideshow frameset with frame control data.

7. The system of claim 4 or 6, wherein the frame control data comprises a time delay period for each photo.

8. The system of claim 1, wherein the means for inputting the photo file references to the slideshow generator is a web-based submission form.

9. The system of claim 8, wherein the web-based submission form comprises one or more fields for entering photo file references, one or more fields for entering photo captions, one or more fields for entering a delay period between photos in the slideshow, one or more fields for entering photo size, and a window in which the slideshow can be viewed prior to publication.

10. The system of claim 9, wherein the web-based submission form further comprises a field for entering the name of the slideshow, a field for entering a reference to a file that will form a background for the photos in the slideshow, a field for entering the font for the slideshow name and the photo captions, and a field for specifying slideshow size.

11. The system of claim 8, wherein the web-based submission form displays a preview of the slideshow after the slideshow file is generated.

12. The system of claim 1, wherein the means for inputting the photo file references to the slideshow generator is an Application Programming Interface call.

13. The system of claim 12, wherein the Application Programming Interface call submits to the slideshow generator metadata regarding slideshow name, slideshow size, photo size, font family and size, and time delay period between photos.

14. The system of claim 13, wherein the metadata submitted by the Application Programming Interface call to the slideshow generator includes file reference information for the photos, textual captions, and size and delay override values.

15. The system of claim 1, wherein the slideshow file is a Graphics Interchange Format file.

16. The system of claim 15, wherein the slideshow file is in GIF89a file format.

17. The system of claim 1, wherein the system allows a publisher to specify a time delay period for each photo or to utilize a default time delay period for all photos.

18. The system of claim 1, wherein the slideshow generator uses Sun Java Simple API for XML to parse the inputted photo file references.

19. The system of claim 1, wherein the slideshow generator uses Sun Java NET library to retrieve photo files based on the parsed photo file references.

20. The system of claim 1, wherein the slideshow generator uses Apache Software Foundation Commons HTTP Client libraries to retrieve photo files based on the parsed photo file references.

21. The system of claim 1, wherein the database is a MySQL relational database.

22. The system of claim 1, wherein the file storage system is a local disk or a remote file storage device.

23. A method for publishing multiple photos in slideshow format on a mobile device comprising:
(a) inputting multiple photo file references to a slideshow generator;
(b) parsing the inputted photo file references, retrieving photos based on the parsed photo file references, assembling the retrieved photo files into frames, and aggregating the frames into a single, animated slideshow file that rotates through all of the photos based on a specified time delay;
(c) storing the photo file reference information in a database;
(d) storing the aggregated slideshow file in a file storage system;
(e) delivering the aggregated slideshow file to a mobile device; and
(f) rendering the slideshow file as a slideshow on a mobile device.

24. The method of claim 23, wherein each frame comprises a background, a header, and a photo file.

25. The method of claim 22, wherein each frame further comprises a textual caption.

26. The method of claim 23, further comprising resizing each retrieved photo file to specified width and height constraints, converting a textual caption into an image file, layering the resized photo and the caption image file on top of a background to create a frame, and appending the frame to a slideshow frameset with frame control data.

27. The method of claim 26, wherein the step of resizing each retrieved photo file to specified width and height constraints is accomplished using Sun Java AWT library functions.

28. The method of claim 26, wherein the steps of converting the textual caption to an image file, layering the resized photo and caption image file on top of a background to create a frame, and appending the frame to a slideshow frameset with frame control data are accomplished using Sun Java 2D library functions.

29. The method of claim 26 or 28, wherein the frame control data comprises a time delay period for each photo.

30. The method of claim 23, wherein the photo file references are inputted using a web-based submission form.

31. The method of claim 30, wherein the web-based submission form comprises one or more fields for entering photo file references, one or more fields for entering photo captions, one or more fields for entering a delay period between photos in the slideshow, one or more fields for entering photo size, and a window in which the slideshow can be viewed prior to publication.

32. The method of claim 31, wherein the web-based submission form further comprises a field for entering the name of the slideshow, a field for entering a reference to a file that will form a background for the photos in the slideshow, a field for entering the font for the slideshow name and the photo captions, and a field for specifying slideshow size.

33. The method of claim 30, wherein the web-based submission form displays a preview of the slideshow after the slideshow is generated.

34. The method of claim 23, wherein the photo file references are inputted using an Application Programming Interface call.

35. The method of claim 34, wherein the Application Programming Interface call submits metadata regarding slideshow name, slideshow size, photo size, font family and size, and time delay period between photos.

36. The method of claim 35, wherein the metadata submitted by the Application Programming Interface call includes file reference information for the photos, textual captions, and size and delay override values.

37. The method of claim 23, wherein the slideshow file is a Graphics Interchange Format file.

38. The method of claim 37, wherein the slideshow file is in GIF89a file format.

39. The method of claim 23, wherein the method allows a publisher to specify a time delay period for each photo or to utilize a default time delay period for all photos.

40. The method of claim 23, wherein the inputted photo file references are parsed using Sun Java Simple API for XML.

41. The method of claim 23, wherein the photo files are retrieved using Sun Java NET library.

42. The method of claim 23, wherein the photo files are retrieved using Apache Software Foundation Commons HTTP Client libraries.

43. The method of claim 23, wherein the database is a MySQL relational database.

44. The method of claim 23, wherein the file storage system is a local disk or a remote file storage device.
